(19) United States
(12) Patent Application Publication
(10) Pub. No.: US 2010/0293469 A1
(43) Pub. Date: Nov. 18, 2010

(54) Providing Portions of a Presentation During a Videoconference

(76) Inventors: Gautam Khot, Bangalore (IN); Prithvi Ranganath, Bangalore (IN); Raghuram Belur, Bangalore (IN); Sandeep Lakshmipathy, Bangalore (IN)

Correspondence Address: MEYERTONS, HOOD, KIVLIN, KOWERT & GOETZEL, P.C., P.O. BOX 398, AUSTIN, TX, 78767-0398, US

(21) Appl. No.: 12/465,741

(22) Filed: May 14, 2009

(51) Int. Cl. G06F 3/01; H04N 7/15

(52) U.S. Cl. 715/730; 348/14.08; 348/E07.083

(57) ABSTRACT

Providing or storing portions of a presentation during a videoconference. One or more portions (e.g., captured images) of a presentation may be stored during a presentation, e.g., in a periodic fashion. The presentation may be provided during a videoconference. The portions may be usable by a user (locally or if, provided over a network, remotely) to view the presentation independently of other participants of the videoconference.

### FIELD OF THE INVENTION

The present invention relates generally to conferencing and, more specifically, to a method for providing portions of a presentation during a videoconference.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to another (remote) participant (or participants). Each videoconferencing system may also include a display and speaker to reproduce video and audio received from one or more remote participants. Each videoconferencing system may also be coupled to (or comprise) a general purpose computer system to allow additional functionality into the videoconference. For example, additional functionality may include data conferencing (including displaying and/or modifying a document for both participants during the conference).

In some cases, participants may provide presentations (e.g., slideshows or other types of presentations) during a videoconference. However, when a participant wishes to view a previous portion of the presentation, he typically has to request that the presenter go back a slide, thereby delaying the presentation for all of the participants. Correspondingly, improvements in videoconferences are desired.

### SUMMARY OF THE INVENTION

Various embodiments are presented of a method for providing portions of a presentation during a videoconference. The method may be implemented as a computer program (e.g., program instructions stored on a computer accessible memory medium that are executable by a processor), a conferencing system (e.g., a videoconferencing system or an audioconferencing system), a computer system, etc.89

A first videoconferencing unit may provide audio and visual data corresponding to a videoconference to one or more participants in the videoconference. The audio and/or visual data may local video and audio data captured from the local participant and may also include a presentation, e.g., a slideshow.

Periodically, the first videoconferencing unit (e.g., of a presenter of the presentation) or a different videoconferencing unit (e.g., of another participant of the videoconference) may periodically store one or more portions corresponding to the presentation. For example, one or more images of the presentation may be captured and stored during the presentation of the videoconference.

These portions may be periodically stored in an automatic fashion, e.g., each time video data corresponding to the presentation changes significantly, or in a manual fashion, as desired. Additionally, the periodic storing may be performed without user input requesting that the portions of the presentation be stored in the first place, thereby allowing a participant to view previous portions of the presentation without interrupting other users, as described herein.

One or more of the stored portions may then be displayed on a display of a videoconferencing unit. For example, where the presenter's videoconferencing unit stores the portions or images of the presentation, one or more of those portions may be provided to another videoconferencing unit. These portions may then be browsed or viewed independently of the presentation or audiovisual data of the videoconference, e.g., based on user input. Alternatively, where the portions are stored locally by one of the other videoconferencing units (i.e., which are not the presenter's), those portions may be provided for display, e.g., in response to user input. Thus, the provision and/or display of the portions of the presentation may be performed in response to user input requesting the portion(s) of the presentation.

In some embodiments, the participant may view (or be able to view) a modified version of the stored portions. For example, a participant may be able to zoom into a captured image of the presentation while browsing the presentation independently of the videoconference.

### BRIEF DESCRIPTION OF THE DRAWINGS

A better understanding of the present invention may be obtained when the following detailed description is considered in conjunction with the following drawings, in which:

FIG. 1 illustrates a videoconferencing system participant location, according to an embodiment;

FIGS. 2A and 2B illustrate exemplary videoconferencing systems coupled in different configurations, according to some embodiments;

FIG. 3 is a flowchart diagram illustrating exemplary methods for storing portions of a presentation during a videoconference, according to an embodiment;

FIGS. 4A and 4B are exemplary illustrations corresponding to the method of FIGS. 3 and 5, according to one embodiment; and

FIG. 5 is a flowchart diagram illustrating exemplary methods for providing portions of a presentation during a videoconference, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

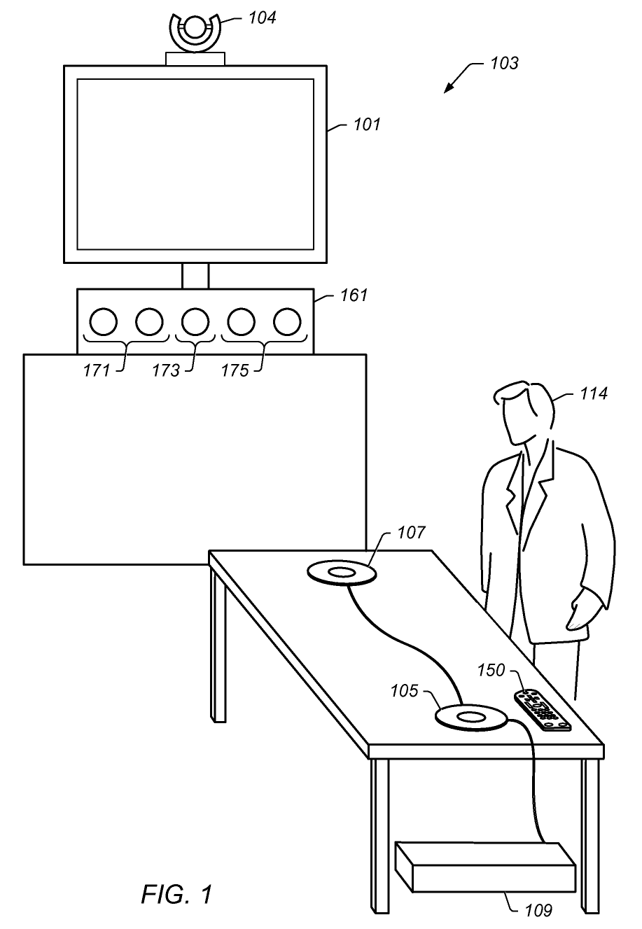

### FIG. 1—Exemplary Participant Location

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on a floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with a network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

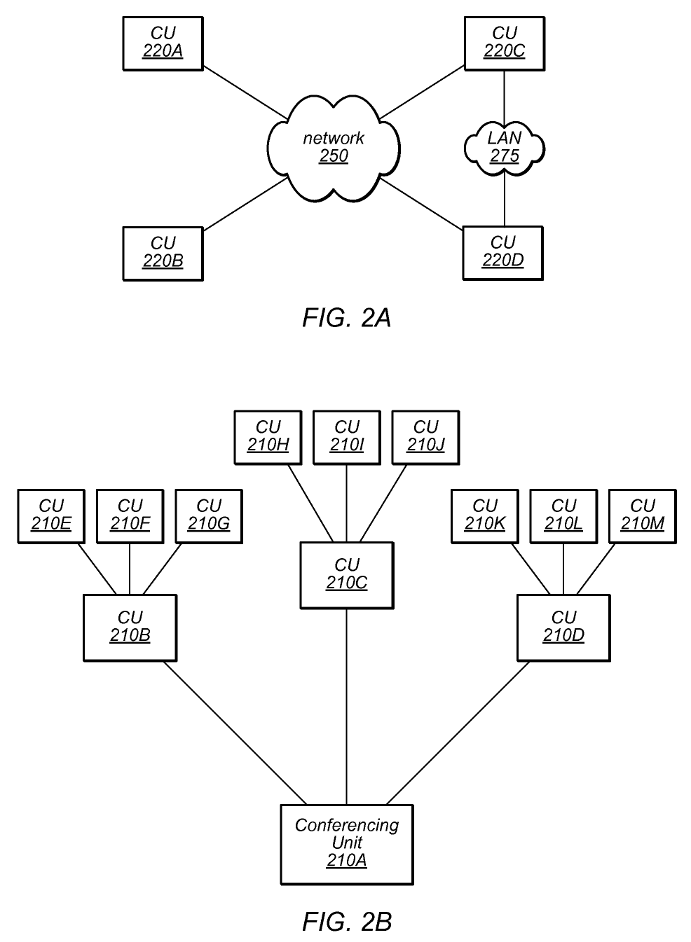

### FIGS. 2A and 2B—Coupled Conferencing Systems

FIGS. 2A and 2B illustrate different configurations of conferencing systems. The conferencing systems may be operable to implement various embodiments described herein. As shown in FIG. 2A, conferencing systems (CUs) 220A-D (e.g., videoconferencing systems 103 described above) may be connected via network 250 (e.g., a wide area network such as the Internet) and CU 220C and 320D may be coupled over a local area network (LAN) 275. The networks may be any type of network (e.g., wired or wireless) as desired.

FIG. 2B illustrates a relationship view of conferencing systems 210A-210M. As shown, conferencing system 210A may be aware of CU 310B-310D, each of which may be aware of further CU's (210E-210G, 210H-210J, and 210K-210M respectively). CU 210A may be operable to provide or store portions of a presentation during a videoconference according to the methods described herein, among others. In a similar manner, each of the other CUs shown in FIG. 2B, such as CU 210H, may be able to also detect and initiate conferences based on participant presence, as described in more detail below. Similar remarks apply to CUs 220A-D in FIG. 2A.

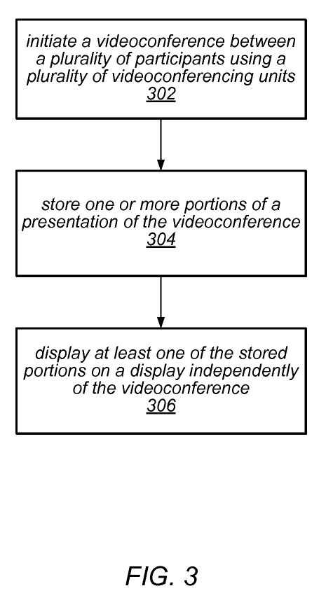

### FIG. 3—Storing Portions of a Presentation

FIG. 3 illustrates a method for storing portions of a presentation during a videoconference. The method shown in FIG. 3 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 302, a videoconference may be initiated between a plurality of participants using a plurality of videoconferencing units. The videoconference may be initiated and conducted according to methods known to those of skill in the art, such as is described in U.S. patent application Ser. No. 11/252,238 which was incorporated in its entirety above. Among other possibilities, the videoconference may include a presentation, e.g., which may be presented by a participant, e.g., a host participant. The presentation may be any of various types of presentations, e.g., a slide show (using, for example, Microsoft PowerPoint™). However, other types of presentations are envisioned, e.g., which include video portions, use software applications, such as graphics applications, word processors, etc., e.g., as is possible in data conferences. However, it should be noted that the presentation itself may not be available for download, e.g., from a central server.

Thus, in 302, audio and visual data corresponding to a videoconference may be provided and received among a plurality of videoconferencing units, e.g., using a data network, such as the Internet. More specifically, in one embodiment, audio and visual data may be received by a first videoconferencing unit of a first participant, e.g., from a second videoconferencing unit of a second participant. The audio and visual data may be encoded according to various formats, e.g., an H239 feed. As indicated above, the videoconference may include a presentation; accordingly, the audio and visual data may include presentation data (e.g., a portion of the video data may correspond to the presentation, and thus may be considered presentation data).

In 304, one or more portions of the presentation may be stored, e.g., by the first videoconferencing unit. In one embodiment, one or more images corresponding to the presentation may be captured during the videoconference. In some embodiments, storing portions of the presentation (e.g., capturing images corresponding to the presentation) may be performed in a periodic manner. For example, the first videoconferencing unit may detect when a significant portion of the video of the presentation has changed, and record and index a new image for the presentation upon that detection.

Alternatively, the videoconferencing unit may simply poll or record images at a set interval, e.g., every 500 ms, 1 s, 2 s, 3 s, 5 s, 10 s, 30 s, etc. Similar to above, the videoconferencing unit may be configured to determine if the polled image is different than the previous image to determine whether a new slide or portion is being presented. In some embodiments, the slides which are determined not to be the same (or significantly different) may be discarded.

In some embodiments, the videoconferencing unit may be able to detect how fast video data of the presentation is changing, and change the polling timing in a dynamic manner. For example, the videoconferencing unit may determine that fast moving material (e.g., of a video) is being presented in the presentation, and correspondingly change the rate at which video frames are recorded to a faster rate, e.g., 30 fps, 15 fps, 10 fps, 5 fps, 1 fps, etc. Thus, where the presenter is providing a slide show and providing detailed explanations for each slide, the polling may be performed every 30 seconds, whereas when the presenter presents a slide with video data, the polling may be performed at a much higher rate, e.g., 30 fps. In some embodiments, the videoconferencing unit may be able to determine the rate of change of the video or images based on information coming from the presenter's videoconferencing unit, e.g., a video encoder of the videoconferencing unit. However, in alternate embodiments, it may be determined that the data is changing too fast and that no capture or portion may be stored since a video clip is being shown.

Thus, each participating videoconferencing unit may take snapshots of the presentation (e.g., of the images being provided or projected) and may mark each such image sequentially in order to build an image set that other participants can browse during the course of the presentation, as described in more detail below.

However, storing portions of the presentation may refer to other methods of recording the presentation. For example, in one embodiment, the first videoconferencing unit may record at least a portion of the presentation, e.g., in a video file. Alternatively, where the presentation is a slideshow, storing a portion of the presentation may refer to the first videoconferencing unit storing, for example, a slide of the presentation in a data file or other data structure.

Note that 304 may be performed in an automatic manner and/or in response to user input. For example, in one embodiment, the first participant may be able to invoke the periodic storage of portions of a presentation, e.g., by entering a “presentation mode”. In such a mode, the videoconferencing unit (or videoconferencing software) may be configured to automatically detect when a new portion of the presentation is being provided and correspondingly automatically store a portion of the presentation without any user input specifying the storage of the portion. In addition to the automatic capturing of portions of the presentation, or alternatively, the first participant (or another participant) may be able to indicate when to store a portion of the presentation, e.g., by pressing a “capture” button, as one example.

In further embodiments, the participant giving the presentation (e.g., the second participant) may indicate, e.g., before the videoconference or during the conference, when a new portion of the presentation is being presented. As one example, each time the participant presses a “next slide” button during the presentation, an indication may be sent to the other videoconferencing units that a new portion is appearing. However, it may be possible that the indication may not be sent on every occurrence of a “next slide” input, e.g., when the participant goes back a slide and then presses the “next slide” button to return to a previously viewed slide. In such cases, an indication may not be sent that a new portion is available. However, the presenter may be able to indicate that a new video frame, slide, presented document, etc. does not really belong in the presentation, and therefore should not be recorded. For example, where the presenter begins discussing a tangential idea or is drawn off topic due to a participant question, the presenter may be able to indicate that slides or documents provided during this tangent should not be recorded as a new portion of the presentation.

In further embodiments, the participant giving the presentation may specifically mark portions of the presentation as a portion that should be captured, and at those locations, the indication may be provided to the viewing videoconferencing units. Note that marking the portions may be performed before the videoconference or the presentation, or may be performed during the presentation (e.g., by pressing a “new portion” button when a new section of the presentation is about to be or is displayed). In some embodiments, the participant marking the portions may be provided on a timeline (e.g., of a video), on each slide of a presentation, etc.

Thus, during the videoconference, the first videoconferencing unit which is receiving data corresponding to the presentation, may capture or store portions of the presentation.

In 306, at least one of the stored portions (e.g., captured images) may be displayed on a display, e.g., of the first videoconferencing unit. In various embodiments, displaying the portions of the presentation may be performed in response to user input (e.g., from the first participant) and may allow the first participant to view or otherwise browse through the presentation independently from the other participants of the videoconference. Said another way, displaying the stored portions during the presentation may be independent of the display of audio and visual data of the videoconference. For example, the videoconference may be displaying a current portion or image of the presentation, but the first participant may be able to independently browse or view previous portions or images of the presentation, without interfering with the provided images viewed by the other participants of the videoconference.

According to various embodiments, the first participant may be able to invoke viewing the stored portions using a remote control of the first videoconferencing unit (e.g., using a particular key combination), using a keyboard, using a pointing device such as a mouse, using voice commands, etc.

The displayed portions of the presentation may be provided in their originally captured form, or may be modified, e.g., in response to user input. For example, in one embodiment, the first participant may be able to zoom in on a portion of a captured image of the presentation. This may be particularly easy when the stored portions are captured as vectored images or video data. However, it should be noted that the portions may be modified in other ways, as desired. As another example, if the portion includes video, the user may be able to watch the video in faster or slower speeds, with different volumes, at different resolutions, etc. In further embodiments, a participant may also be able to perform basic image operations such as cut, copy, paste, etc. of the image or text recognized inside the image. Further operations may be performed such as resizing (as indicated above), appending comments to images, etc. Such operations may be performed using a pointing device, a remote, a touch based panel, etc.

Note that the method described above may be performed by each videoconferencing unit that is receiving the presentation, thus where a participant is giving the presentation, each “listening” videoconferencing unit may be performing the method described above, according to various embodiments.

### Exemplary Use

The following provides an example of the method described above. Note that the following descriptions are exemplary only and that other embodiments are envisioned.

Two parties may be involved in a videoconference and one of the participants (the presenter) may share a slide show presentation as a H.239 feed.

Each time the presenter moves to a new page, the videoconferencing unit (e.g., of the participants receiving the presentation) may poll every 500 milliseconds, 1 second, 2 seconds, 5 seconds, 10 seconds, etc. to determine if the currently provided or projected image has changed. The videoconferencing unit may capture a snapshot (e.g., in JPEG, a vector based format, or any other audiovisual format) each time the image has changed and/or each time a polling occurs.

When a new page is displayed, the previous snapshot image may be indexed sequentially and stored in storage, e.g., temporary storage.

During the course of the meeting any of the other attendees on the receiving end may attempt to go to a previous page of the presentation, e.g., using a remote control key option provided. These participants may then access the stored snapshots on their respective videoconferencing units to view the previous data.

In this case, the videoconferencing unit may display the stored snapshots in the given order so that the participant can go to any previous slide he would like, and then rejoin the mainstream presentation conference once he has finished. The participant may rejoin the videoconference feed, e.g., by pressing a particular button or key combination on the remote control.

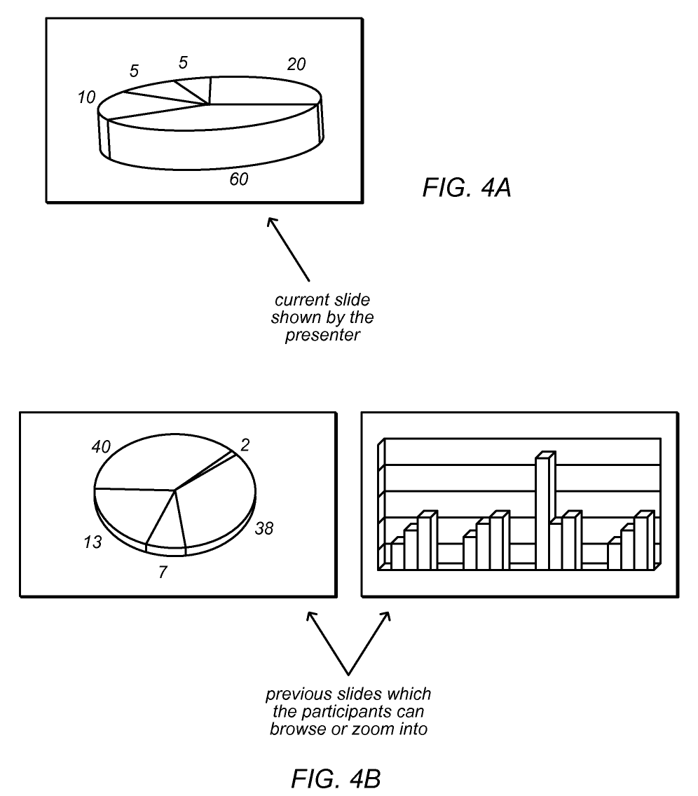

FIGS. 4A and 4B provide an example of the methods described herein. As shown, in FIG. 4A a particular pie chart may be currently shown by the presenter of the presentation. However, as shown in FIG. 4B two previous slides (a different pie chart and a bar graph) may be viewed independently by viewing participants. As also noted, the participants may be able to browse these previous slides and may zoom in one these images. Note that a first viewing participant may be viewing the previous pie chart and a second viewing participant may be viewing the previous bar graph while the presenting participant may be explaining the pie chart of FIG. 4A. Thus, each user may independently view portions of the presentation, whether being currently provided or presented or not, as desired.

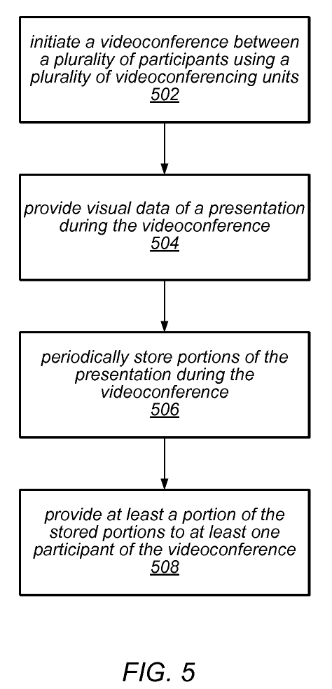

### FIG. 5—Providing Portions of a Presentation

FIG. 5 illustrates a method for providing portions of a presentation during a videoconference. The method shown in FIG. 5 may be used in conjunction with any of the methods or systems described herein. In various embodiments, some of the method elements shown may be performed concurrently, performed in a different order than shown, or omitted. Additional method elements may also be performed as desired. As shown, this method may operate as follows.

In 502, a videoconference may be initiated between a plurality of participants using a plurality of videoconferencing units. The videoconference may be initiated in a manner similar to the one described above in 302.

In 504, audio and/or visual data of a presentation (“presentation data”) may be provided during the videoconference. The presentation data may be provided from a first videoconferencing unit of a presenting participant (“presenter”) to one or more other videoconferencing units of other participants of the videoconferencing units. The data of the videoconference and of the presentation may be provided similar to the manner described above in 302.

In 506, portions of the presentation may be periodically stored during the videoconference. The portions may be stored similarly to that described in 304 above; however, in the embodiments of FIG. 5, the videoconferencing unit of the presenter may perform the storing rather than the videoconferencing units of the other participants.

In 508, at least a portion of the stored portions may be provided to at least one participant of the videoconference. More specifically, the videoconferencing unit of the presenter may provide the portion(s) to corresponding videoconferencing units of the other participant(s) over a network, such as the Internet. For example, one of the other participants may request that a slide or video of the presentation be provided, and the videoconferencing unit of the presenter may provide the corresponding slide or video portion. In further embodiments, a participant may request all previous slides of the presentation, e.g., for a late joining participant. In such cases, all of the stored portions may be provided to a corresponding videoconferencing unit of the requesting participant. Alternatively, or additionally, each time a new portion is stored, it may be provided to all of the participants, although other embodiments are envisioned.

The provided portions may be usable by one or more receiving participants to view the presentation independently of other participants of the videoconference. Thus, similar to descriptions above, each participant may be able to browse through the presentation without interrupting the presentation or the current slide being provided to the other participants.

### Further Embodiments

The method described above may be extended to capture presentations provided from a plurality of different participants, e.g., where a first participant presents a first portion of the presentation and a second participant presents a second portion of the presentation. In such cases, the method may be applied to capture from each of the participants separately, but may allow a listening or viewing participant to browse the entire presentation. The method may be extended to any number presenting participants, as desired. However, in some embodiments, the method may be able to parse and identify different presentations, e.g., where a first participant is providing a first presentation and a second participant is providing a second different presentation. In such cases, the videoconferencing unit may separate the two presentations and allow browsing of each of the presentations, as desired.

Additionally, in further embodiments, capturing portions of the presentation may allow remote browsing even when a videoconferencing unit of a remote viewer is not directly connected to the videoconferencing unit of the presenter, and/or in cases where a viewing videoconferencing unit is more than one “hop” away from the presenting videoconferencing unit.

Furthermore, the method may provide the ability to perform image comparison. For example, in a situation where several participants are discussing the same presentation, a participant may request for comparison of a particular snapshot, and the method may prompt a closest matching snapshot, e.g., compared against all possible sources (e.g., the snapshots stored by the plurality of videoconferencing units). Alternatively, or additionally, the method may allow the participant to select a snapshot for comparison. Accordingly, the method may highlight the differences between the snapshots, e.g., on a display of one or a plurality of the videoconferencing units. The method of comparison could be anything from comparing groups of pixels to advanced text comparison based on language specific text recognized in each of the compared snapshots.

In additional embodiments, portions of a presentation may be provided before they are presented by the participant giving the presentation. For example, the videoconferencing unit of the presenter may provide portions or screen captures of future slides of a slideshow. In such embodiments, listening or viewing participants may be able to browse ahead of the presenter before the slides or future portions are provided in the presentation.

Note that in some embodiments, the presenter may have the option to disable the methods described above, e.g., for a portion of the presentation, or for all of the presentation, as desired. Thus, in these cases, the presenter may be able to ensure that all of the participants are providing all of their attention to the current slide rather than viewing previous or future slides. Additionally, the browsing ability can be made available only for the duration of the presentation and can be made inaccessible once the main presenter stops the presentation (although in alternate embodiments, the presentation may be browsed at any point). In particular, the presenter may have the ability to disable viewing future portions of the presentation.

### Advantages

There are several advantages to the prior art using the methods described above. For example, by using the methods above, there is no change to the presenter while each viewing participant is able to browse the presentation independently of the currently projected image or portion of the presentation. This may be particularly useful when a participant of the videoconference joins the videoconference late, e.g., after the presentation has begun. In such cases, the participant may be able to view previous slides without interrupting the presentation or requiring all of the participants to go back or start the presentation over.

Additionally, the presenter is not required to upload any file to a central server. For example, with this decentralized solution, each participant may have independent access to browse the presentation as required, without having to rely on provision of the material from the central server.

Further, since the snapshots may be used in place of an actual feed (e.g., in the case where future slides may be provided to the participants of the videoconference), the presenter may be able to disconnect the feed from his machine, e.g., for an emergency task.

Similarly, since the presentation is captured and stored, the method described above may allow for archival of presentations, thereby allowing participants to view previous presentations, e.g., in a future videoconference or in an offline mode, as desired.

Finally, the method described above may scale well in order to handle multiple presentation delivered by different organizers, e.g., who present material to the participants of the videoconference in a round robin fashion. In such embodiments, the end points can categorize and handle the individual snapshots so as to allow fine grained access to all the presented material during the course of the presentation.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method, comprising:
providing, by a computer system, audio and visual data corresponding to a videoconference to one or more participants in the videoconference, wherein the visual data includes a presentation;
periodically capturing, by the computer system, one or more images corresponding to the presentation in the videoconference, wherein said periodically capturing is performed during the videoconference;
providing, by the computer system, at least one captured image to at least one of the one or more participants during the videoconference, wherein the at least one of the captured images is usable by the at least one participant to view the presentation independently of other participants of the videoconference.

2. The method of claim 1, wherein said providing is performed in response to user input requesting the at least one captured image.

3. The method of claim 1, wherein said periodically capturing is performed automatically without user input requesting performing said periodically capturing.

4. The method of claim 1, wherein said periodically capturing is performed each time video data corresponding to the presentation changes significantly.

5. The method of claim 1, wherein said providing is performed a plurality of times throughout the videoconference.

6. A computer readable memory medium comprising program instructions, wherein the program instructions are executable to:
provide audiovisual data corresponding to a videoconference to one or more participants in the videoconference;
provide presentation data corresponding to a presentation during the videoconference;
periodically store portions of the presentation data during the videoconference;
provide at least a first portion of the stored portions of the presentation data to at least one of the one or more participants during the videoconference, wherein the first portion of the presentation data is usable by the at least one participant to view the presentation independently of other participants of the videoconference.

7. The memory medium of claim 6, wherein said providing is performed in response to user input requesting the at least the first portion.

8. The memory medium of claim 6, wherein said periodically storing is performed automatically without user input requesting performing said periodically capturing.

9. The memory medium of claim 6, wherein said periodically storing is performed each time video data corresponding to the presentation is significantly different than previous video data.

10. A system, comprising:
a processor;
a network interface coupled to the processor, wherein the network interface is configured to perform communication over a network;
a computer readable memory medium coupled to the processor, wherein the memory medium comprises program instructions that are executable by the processor to:
provide audiovisual data corresponding to a videoconference to one or more participants in the videoconference over the network;
provide presentation data corresponding to a presentation over the network during the videoconference;
periodically store portions of the presentation data during the videoconference;
provide at least a first portion of the stored portions of the presentation data to at least one of the one or more participants over the network during the videoconference, wherein the first portion of the presentation data is usable by the at least one participant to view the presentation independently of other participants of the videoconference.

11. A method, comprising:
a computer system receiving audio and visual data corresponding to a videoconference via a network, wherein the visual data includes a presentation;
the computer system periodically capturing one or more images corresponding to the presentation in the videoconference, wherein said periodically capturing is performed during the videoconference;
in response to user input, the computer system displaying at least one of the captured images on a display, wherein said displaying is performed during the videoconference, wherein said displaying the at least one of the captured images is performed independently of said receiving audio and visual data.

12. The method of claim 11, wherein said providing is performed in response to user input requesting the at least one captured image.

13. The method of claim 11, wherein said periodically capturing is performed automatically without user input requesting performing said periodically capturing.

14. The method of claim 11, wherein said periodically capturing is performed each time video data corresponding to the presentation changes significantly.

15. The method of claim 11, wherein said displaying comprises displaying a modified version of the at least one of the captured images.

16. A computer readable memory medium comprising program instructions, wherein the program instructions are executable to:
receive audio and visual data corresponding to a videoconference via a network, wherein the visual data comprises presentation data corresponding to a presentation;
periodically store portions of the presentation data during the videoconference;
in response to user input, display at least a portion of the stored portions of the presentation data on a display, wherein said displaying is performed during the videoconference, wherein said displaying the at least a portion of the stored portions of the presentation data is performed independently of said receiving the audio and visual data.

17. The memory medium of claim 16, wherein said periodically capturing is performed automatically without user input requesting performing said periodically capturing.

18. The memory medium of claim 16, wherein said periodically capturing is performed each time video data corresponding to the presentation changes significantly.

19. The memory medium of claim 16, wherein said displaying comprises displaying a modified version of the at least one of the captured images.

20. A system, comprising:
a processor;
a network interface coupled to the processor, wherein the network interface is configured to perform communication over a network;
a display coupled to the processor;
a computer readable memory medium coupled to the processor, wherein the memory medium comprises program instructions that are executable by the processor to:
receive audio and visual data corresponding to a videoconference via the network, wherein the visual data comprises presentation data corresponding to a presentation;
periodically store portions of the presentation data during the videoconference;
in response to user input, display at least a portion of the stored portions of the presentation data on the display, wherein said displaying is performed during the videoconference, wherein said displaying the at least a portion of the stored portions of the presentation data is performed independently of said receiving the audio and visual data.
